(19) United States
(12) Patent Application Publication
(10) Pub. No.: US 2008/0243587 A1
(43) Pub. Date: Oct. 2, 2008

(54) Increasing Incremental Spend By A Consumer

(75) Inventors: Lulinyu Laura Chang, Bayside Hills, NY (US); Shen Y. Chang, Rockaway, NJ (US); Venkat Varadachary, New York, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc.

(21) Appl. No.: 11/694,086

(22) Filed: Mar. 30, 2007

(51) Int. Cl. G07G 1/14

(52) U.S. Cl. 705/10

(57) ABSTRACT

A rewards program has been developed that increases incremental spend by a consumer while maximizing the profits to a transactional account company. In an embodiment, a predicted spend of a given consumer over a given time period is calculated. A spend threshold for the consumer is set based on the predicted spend over the given time period. An incremental spend reward offer is then customized for the consumer, where the offer maximizes profits resulting from the offer based on a calculation of consumer profits derived from campaign group responses. The customization may involve, for example, simulating a response of the given consumer to an offer having various combinations of incentive variables, with the customized offer including the combination of incentive variables that maximizes profits resulting from the offer in the simulation. The consumer is rewarded for spend above the spend threshold during the given time period.

### BACKGROUND

1. Field of the Invention

The present invention relates to consumer loyalty programs, particularly to increasing incremental consumer spend through a loyalty program.

2. Background Art

Previous customer loyalty programs rewarded spend by a consumer based on a total spend of the consumer. That is, if a consumer spent, for example, $200, then the reward given to that consumer was calculated based on the total $200 spend. The only way to incentivize additional spend under such a loyalty program is to increase the reward for total spend. However, it is beneficial to a transactional account company that offers the loyalty/rewards program for its customers to increase their incremental spend. Incremental spend, also referred to as spend lift, is the amount of spend that is greater than the customer's traditional spend level. For example, if a customer traditionally spends $200 a month, then a spend of $250 in one month results in an incremental spend of $50.

In order to encourage customers to spend at a higher level than they have in the past, it is important that the offer to the customer is one that the customer will likely accept. At the same time, it is also important for the incremental spend rewards program be profitable to the transactional account company. What is needed is a system and method for incentivizing customers to increase their incremental spend while maximizing the profits to the transactional account company.

### BRIEF SUMMARY OF THE INVENTION

A rewards program has been developed that increases incremental spend by a consumer while maximizing the profits to a transactional account company. In an embodiment, a set of consumer behavior models (including, for example and without limitation, spend, response, attrition, spend lift, spend persistency, etc.) are developed based on the campaign population. For example, a predicted spend of a given consumer over a given time period is an output from a spend model, which is a function of customer profile information, historical transactions, spend capacity, spend ability, and value proposition. In another example, a predicted response rate is an output from a response model, which is a function of the above-mentioned variables as well as incentive variables (including, for example and without limitation, duration, fee, spend threshold, and rewards cap). To derive the optimal customized incentive offer for the next campaign, a spend threshold for the consumer may be set based on the predicted spend over the given time period. An incremental spend reward offer is then customized for the consumer, where the offer maximizes profits resulting from the offer based on a calculation of consumer profits, which may include the above-mentioned set of consumer behavior models, business financial inputs, and/or business judgments. The customization may involve, for example, simulating a response of the given consumer to an offer having various combinations of incentive variables, with the customized offer including the combination of incentive variables that maximizes profits resulting from the offer in the simulation. The offer is provided to the consumer, and the consumer is rewarded for spend above the spend threshold during the given time period.

In an embodiment, to create the calculation of consumer profits, offers for rewarding incremental spend having a plurality of offer types are sent to consumers, each offer type having a different combination of incentive variables. Enrollment data and/or usage data is received for each set of offers. Each incentive variable is then mapped to consumer data (including, for example and without limitation, customer profile information, historical transactions, spend capacity, spend ability, value proposition, etc.) of the campaign population for the development of consumer behavior models. The calculation of consumer profits is derived based on the above-mentioned set of customer behavior models, business financial inputs, and/or business judgments.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart of an exemplary method for creating a calculation of consumer profits.

FIG. 2 is a flowchart of an exemplary method for customizing an offer for an individual consumer.

FIG. 3 is an illustration of how a simulation may be used according to an embodiment of the present invention.

FIG. 4 is a flowchart of an exemplary method for processing a response to a customized offer.

FIG. 5 is a block diagram of an exemplary computer system useful for implementing the present invention.

The present invention will be described with reference to the accompanying drawings. The drawing in which an element first appears is typically indicated by the leftmost digit(s) in the corresponding reference number.

### DETAILED DESCRIPTION OF THE INVENTION

### I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer,” “customer,” “participant,” “cardmember,” and/or the plural form of these terms are used interchangeably throughout herein to refer to those persons or entities capable of accessing, using, being affected by and/or benefiting from the tool that the present invention provides for increasing incremental spend.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

### 1. Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

### 2. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

### II. Modeling an Incremental Spend Rewards Program

An incremental spend rewards program has been developed that rewards consumers for spend during a given time period that is greater than their typical spend level. The amount of spend greater than the consumer's typical spend level is referred to herein as the “incremental spend” or “spend lift.” An offer provided to a consumer can be customized to the consumer's typical spend level so that profit from the offer can be maximized. The customization of the offer may be based on a calculation of consumer profits.

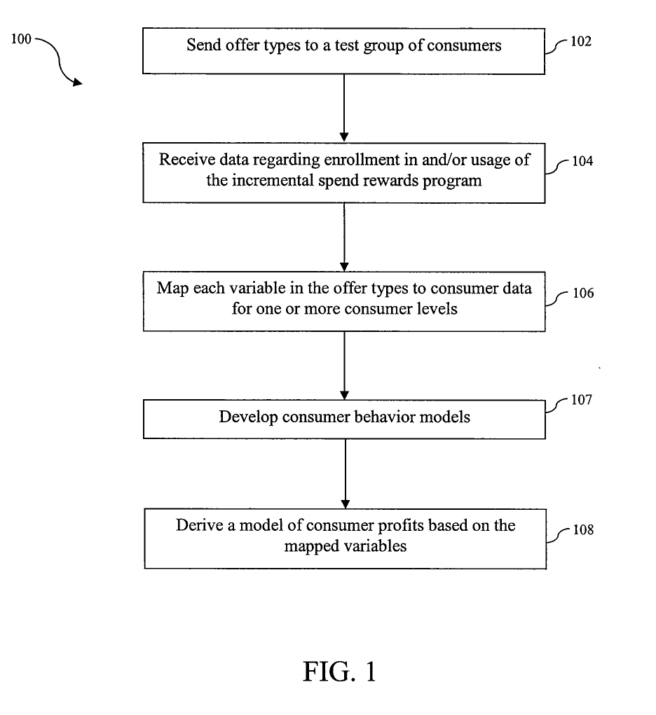

FIG. 1 is a flowchart of an exemplary method 100 for creating a calculation of consumer profits. In step 102, various types of offers for rewarding incremental spend are sent to a campaign group of consumers (that is, a group of consumers who are chosen to receive an offer in the offer campaign) by a transactional account company seeking to increase the incremental spend of its customers. Although the present invention will be described with reference to the involvement of a transactional account company, one of skill in the art will recognize that other parties may, additionally or alternatively, be involved without departing from the spirit and scope of the present invention. Such other parties may include, for example and without limitation, agents of a transactional account company, intermediaries between consumers and a transactional account company, and rewards program administrators.

The offer sent to the consumers in the campaign group offers enrollment in an incremental spend rewards program. Each consumer in the campaign group receives one of the offer types. Each offer type has a different combination of incentive variables from other offer types. The incentive variables may include, for example and without limitation, one or more of spend threshold, duration, rewards cap, and fee. For example, one offer type may have a threshold of $1000, a duration of 3 months, a fee of $10, and a rewards cap of $5000. Another offer type may have a threshold of $500, a duration of 6 months, no fee, and a rewards cap of $4000. Each offer type is sent to consumers in a variety of consumer levels. The consumer levels are defined based on, for example and without limitation, the consumer profile, consumer demographic information, consumer spend capacity, rewards program enrollment information of the consumer, and information on the relationship between the consumer and the transactional account company.

In step 104, data regarding the enrollment in and/or usage of the incremental spend rewards program is received by the transactional account company for each offer type. This data may include, for example and without limitation, the response rate of the consumers, a response indicator, a total spend, the amount of incremental spend that accrued due to the offer, an attrition benefit due to the offer, an attrition indicator, and the spend persistence of the consumers over a given period of time.

In step 106, each variable in the offer types is mapped to consumer data (including, for example and without limitation, customer profile information, historical transactions, spend capacity, spend ability, and value proposition) of the campaign population for one or more consumer levels based on the data received in step 104. In order to map the variables, the data resulting from one offer type is compared to data from at least one other offer type. The data resulting from an offer type may also be compared to data from a control group. The control group includes customers who did not receive an incremental spend reward offer from the transactional account company. If a control group is used, the data received in step 104 may also include the spend of the control group and the attrition rate of the control group. For a given consumer level, a table may be developed that indicates the correlation between each incentive variable and consumer spend behavior.

In step 107, a set of consumer behavior models is developed. The set of consumer behavior models may include, for example and without limitation, a spend model, a response model, an attrition model, a spend lift model, and/or a spend persistency model. The set of consumer behavior models is developed based on the mapped variables for the campaign group. Each behavior model is a function of one or more of customer profile information, historical transactions, spend capacity, spend ability, value proposition, and the incentive variables.

In step 108, a calculation of consumer profits is derived based on at least one of the set of consumer behavior models developed in step 107, business financial inputes, and business judgments. In one embodiment, the calculation indicates the effect of each consumer behavior model on the net profits earned by the transactional account company for a given consumer based on profile/demographic information of that consumer. The calculation may receive information about a given consumer and output values of the incentive variables that provide the highest profit to the transactional account company. Alternatively, the calculation may receive information about the computer and output the estimated profits for one or more combinations of variables. The estimated profits can then be analyzed to determine which combination of incentive variables provides the highest profit to the transactional account company.

### III. Targeting Consumers to Increase Incremental Spend

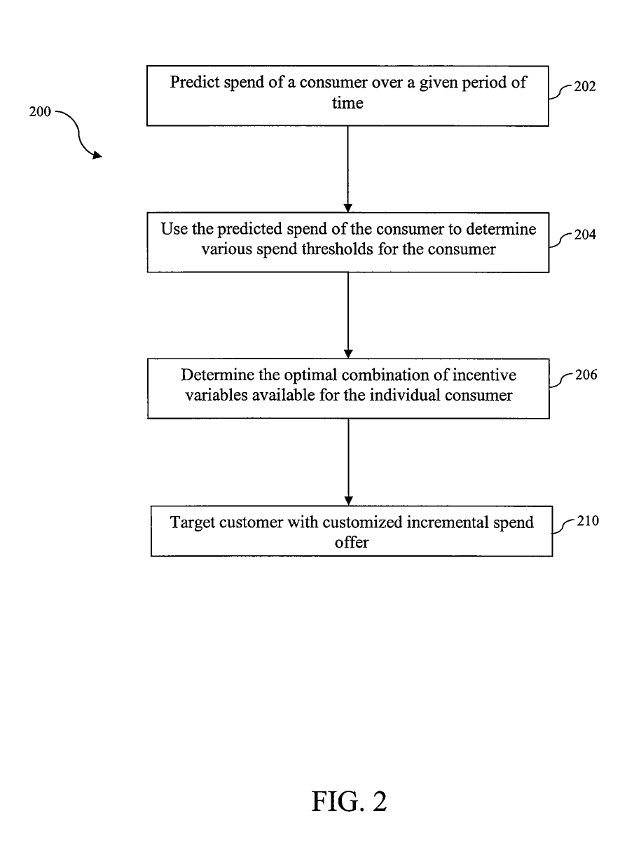

Once the calculation of consumer profits has been developed, it can be used to customize incremental spend reward offers for a consumer such that profits resulting from the offer are maximized to the transactional account company. FIG. 2 is a flowchart of an exemplary method 200 for customizing an offer for an individual consumer and targeting the consumer with the customized offer.

In step 202, a predicted spend of the consumer over a given period of time (e.g., monthly spend over the next year) is an output from a spend model, which may be a function of one or more of customer profile information, historical transactions, spend capacity, spend ability, and value proposition. The spend model may include, for example, the size of wallet model disclosed in U.S. patent application Ser. No. 10/978,298, which is incorporated by reference herein in its entirety.

In step 204, the predicted spend of the individual consumer over the given period of time is used to determine an optimal spend threshold for the consumer. The spend threshold is the minimum amount that the consumer must spend before becoming eligible for the incremental spend reward. The optimal spend threshold may also take into consideration various other factors, such as profile/demographic information of the consumer.

In step 206, the optimal combination of incentive variables for the individual consumer is determined using the calculation of consumer profits derived in step 108 of method 100 (FIG. 1). Inputs to the calculation may include, for example and without limitation, the predicted spend, attrition, spend lift, and spend persistence of the consumer, as well as business financial inputs and business judgment. In an embodiment, to determine the best incremental spend reward offer, a simulation may be run that simulates the individual consumer's response to a variety of incentive variables. As discussed above, those incentive variables may include, for example, rewards cap, duration, and fee. Any number of incentive variable combinations (that is, offer types) may be used in the simulation. The offer is then set to include the optimal combination of incentive variables that results in the highest profit to the transactional account company. The optimal spend threshold determined in step 204 is combined with the optimal combination of incentive variables to produce an optimized incremental spend reward offer.

One of skill in the art will recognize that steps 204 and 206 may be performed separately, or they may be combined into a single step, in which various spend thresholds are considered in the simulation, without departing from the spirit and scope of the present invention.

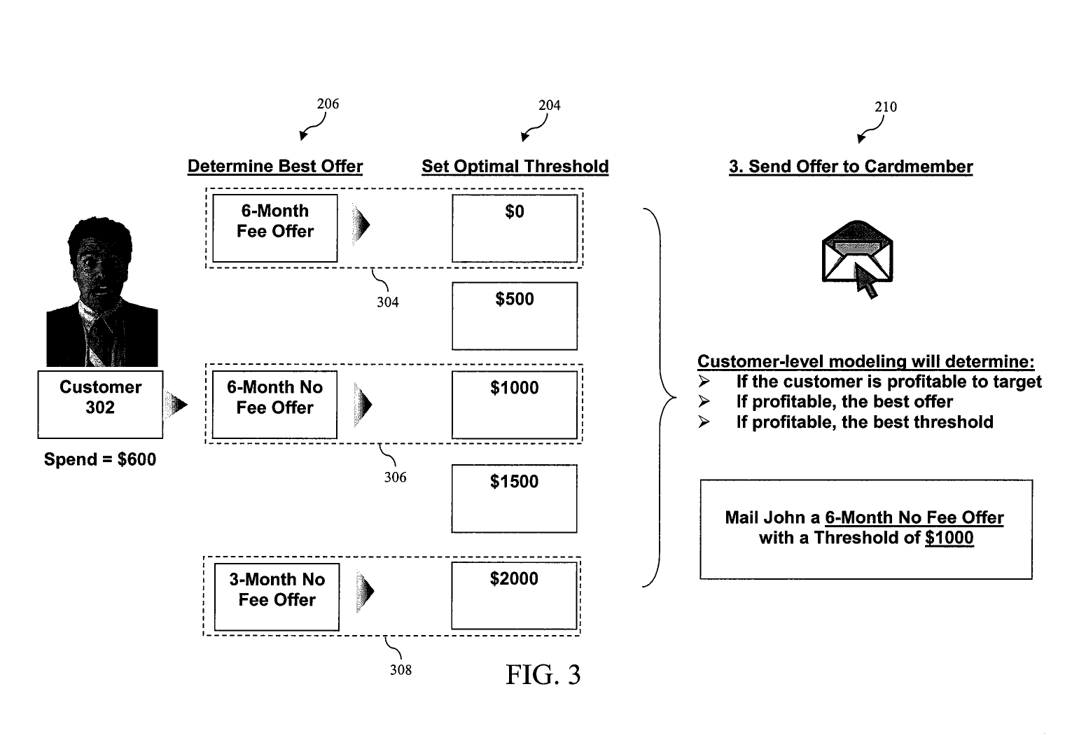

FIG. 3 is an illustration of how the simulation may be used to determine the best offer for a given consumer 302, according to an embodiment of the present invention. Consumer 302 is predicted to have a monthly spend of $600 without any additional incentive. At step 206, the simulation sets the variables for duration and fee at different values to determine the result. For example, in simulation 304, the duration variable is set at 6 months, the fee variable is set to “yes”, and the spend threshold variable is set at $0. In simulation 306, the duration variable is set at 6 months, the fee variable is set to “no”, and the spend threshold variable is set at $1000. In simulation 308, the duration variable is set to 3 months, the fee variable is set to “no”, and the spend threshold variable is set to $2000. Any number of other combinations of duration variable, fee variable, and spend threshold variable may also be simulated. The result of each of these simulations is determined based on the calculation of consumer profits discussed above.

As shown in FIG. 3, several different options for the spend threshold variable are allowed by the transactional account company. The value of the monthly spend of consumer 302 may be used to determine the optimal offer including the spend threshold for the offer for consumer 302. In this example, the monthly spend of consumer 302 is $600. There would be no incentive for consumer 302 to increase his incremental spend if the threshold were set at, for example, $0 or $500. On the other hand, thresholds of $1500 or $2000 may be too great, causing consumer 302 to possibly ignore the offer as having an unattainable reward. Therefore, a spend threshold of $1000 is chosen, as it is more likely that consumer 302 will increase his incremental spend in response to the reward offer having a threshold of $1000 as compared to the other threshold options. Based on steps 204 and 206 in the example of FIG. 3, the optimal offer for consumer 302 is a 6 month, no fee offer having a threshold of $1000.

Returning to FIG. 2, once the offer has been optimized, method 200 proceeds to step 210. In step 210, the consumer is targeted with the customized incremental spend reward offer. The offer may be provided to the consumer in a variety of ways including, for example and without limitation, direct mail and email.

Using the estimated profit obtained in step 204 and/or step 206, the consumers may be ranked based on their highest predicted profits. Depending on the budget available for the marketing campaign that is targeting consumers with the incremental spend reward offer, the marketing campaign can maximize use of limited available funds by targeting only the most profitable consumers.

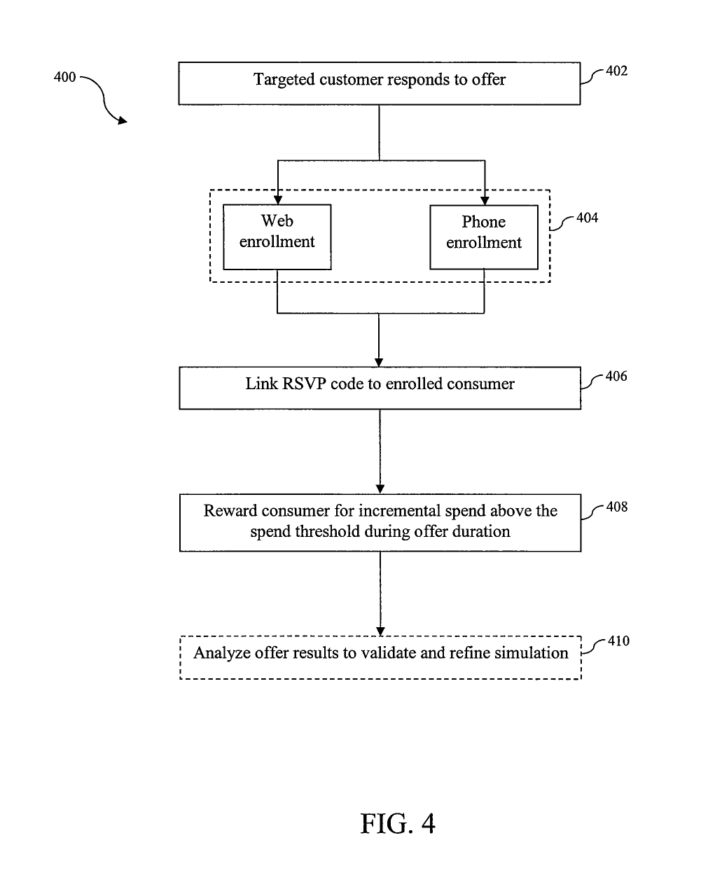

FIG. 4 illustrates an exemplary method 400 for processing a response to a customized offer. In step 402, a targeted customer responds to the customized offer sent in step 210 of method 200 (FIG. 2). Once the response is received, the consumer is requested to enroll in the incremental spend reward program.

In step 404, the consumer enrolls in the incremental spend reward program. In one embodiment, the consumer enrolls via a webpage run by, for example, the transactional account company. In another embodiment, the consumer enrolls via a telephone call with, for example, the transactional account company. During step 404, if the offer included the payment of an enrollment fee, the specified fee may be paid at this time. In an embodiment, the fee is deducted from the consumer's transactional account associated with the incremental spend reward program.

In step 406, the RSVP code associated with the customized offer is linked to the enrolled consumer. Such linking allows the transactional account company to track the post-enrollment spend habits of the consumer, as well as determine how the spend habits of the consumer changed as a result of the incremental spend reward offer.

In step 408, the consumer is rewarded for any incremental spend above the spend threshold during the time period specified in the offer. Such a reward may be in the form of, for example, rewards points, cash-back, etc. Such a reward may be subject to a rewards cap specified in the offer, meaning that the incremental spend reward may not be provided once the rewards cap has been reached. The reward may be awarded to the customer periodically, or at the end of the offer duration period.

The incremental spend reward may be a stand-alone or substitute reward. Alternatively, the incremental spend reward may be applied in addition to rewards from an existing rewards program, to incentivize existing rewards program customers to increase their spend beyond their typical spend level. The incremental spend reward offer may be targeted to existing rewards program customers. The incremental spend reward offer may, additionally or alternatively, be targeted to consumers who are not existing rewards program customers. If the consumers are not existing rewards program customers, enrollment in the incremental spend rewards program may also include enrollment in the existing rewards program of the transactional account company.

In step 410, the results of the incremental spend offer are analyzed with respect to the simulation originally run for the targeted consumer in step 210. In this manner, the results of the offer can be used to further modify the consumer behavior models and/or the simulation to provide a more accurate model and/or simulation for the next campaign.

### IV. Example Implementations

The present invention (or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

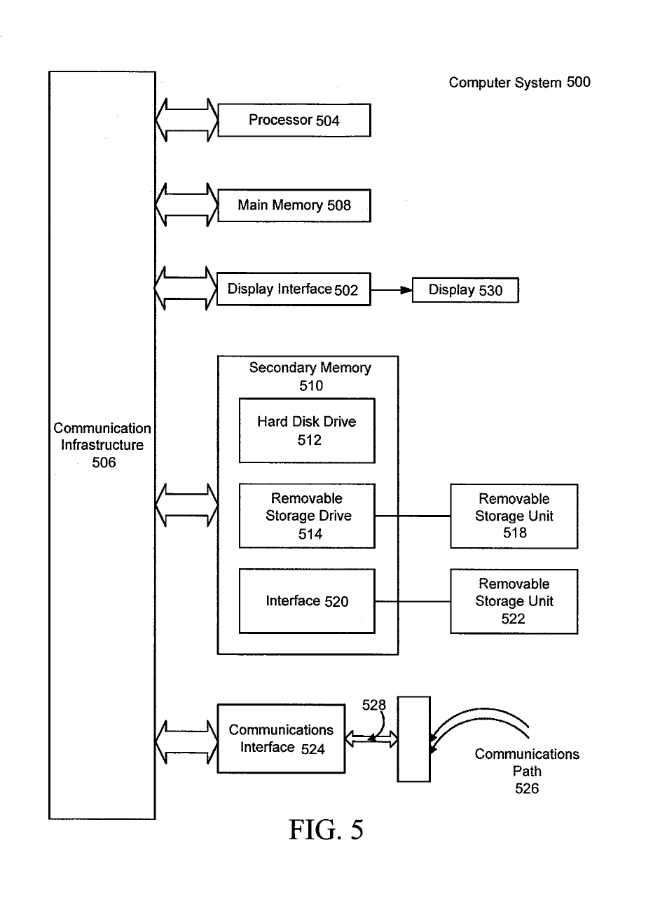

In fact, in one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 514 and a hard disk installed in hard disk drive 512. These computer program products provide software to computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for increasing incremental spend by a consumer, comprising:
calculating a predicted spend of the consumer over a given time period;
setting a spend threshold for the consumer based on the predicted spend over the given time period; and
rewarding the consumer for spend above the spend threshold during the given time period.

2. The method of claim 1, further comprising:
customizing an incremental spend reward offer for the consumer that maximizes profits resulting from the offer based on a calculation of consumer profits; and
providing the consumer with the customized incremental spend reward offer.

3. The method of claim 2, wherein the calculation of consumer profits provides an optimal value for at least one variable, wherein the at least one variable is at least one of: spend threshold, duration, rewards cap, and fee.

4. The method of claim 2, further comprising linking the customized incremental spend reward offer with an RSVP code that allows validation of the calculation of consumer profits.

5. The method of claim 2, further comprising:
sending offers for rewarding incremental spend having a plurality of offer types to consumers, each offer type having a different combination of variables;
receiving at least one of enrollment data or usage data for each set of offers;
mapping each incentive variable to a spend behavior for a given consumer level based on the at least one of enrollment data or usage data;
developing a set of consumer behavior models based on the mapped variables; and
deriving the calculation of consumer profits based on at least one of the mapped variables, business financial inputs, and business judgments.

6. The method of claim 5, wherein the at least one of enrollment data or usage data includes at least one of the following:
response rate;
a response indicator;
spend;
spend of a control group;
incremental spend due to the offer;
attrition rate of a control group;
attrition benefit due to the offer;
an attrition indicator; and
spend persistence over a given period of time.

7. The method of claim 2, wherein the customizing step comprises:
simulating a response of the consumer to a plurality of offers having different combinations of incentive variables based on the calculation of consumer profits to identify a profit; and
setting the incentive variables in the customized incremental spend reward offer based on the given combination that maximizes profits resulting from the offer in the simulation.

8. A system for increasing incremental spend by a consumer, comprising:
a processor; and
a memory in communication with the processor, the memory for storing a plurality of processing instructions for directing the processor to:
calculate a predicted spend of the consumer over a given time period;
set a spend threshold for the consumer based on the predicted spend over the given time period; and
reward the consumer for spend above the spend threshold during the given time period.

9. The system of claim 8, further comprising instructions for directing the processor to:
customize an incremental spend reward offer for the consumer that maximizes profits resulting from the offer based on a calculation of consumer profits; and
provide the consumer with the customized incremental spend reward offer.

10. The system of claim 9, wherein the calculation of consumer profits provides an optimal value for at least one variable, wherein the at least one variable is at least one of: spend threshold, duration, rewards cap, and fee.

11. The system of claim 9, further comprising instructions for directing the processor to link the customized incremental spend reward offer with an RSVP code that allows validation of the calculation of consumer profits.

12. The system of claim 9, further comprising instructions for directing the processor to:
send offers for rewarding incremental spend having a plurality of offer types to consumers, each offer type having a different combination of incentive variables;
receive at least one of enrollment data or usage data for each set of offers;
map each incentive variable to a spend behavior for a given consumer level based on the at least one of enrollment data or usage data;
develop a set of consumer behavior models based on the mapped variables; and
derive the calculation of consumer profits based on at least one of the mapped variables, business financial inputs, and business judgments.

13. The system of claim 12, wherein the at least one of enrollment data or usage data includes at least one of the following:
response rate;
a response indicator;
spend;
spend of a control group;
incremental spend due to the offer;
attrition rate of a control group;
attrition benefit due to the offer;
an attrition indicator; and
spend persistence over a given period of time.

14. The system of claim 9, wherein the instructions for directing the processor to customize comprise instructions for directing the processor to:
simulate a response of the consumer to a plurality of offers having different combinations of incentive variables based on the calculation of consumer profits to identify a profit; and
set the incentive variables in the customized incremental spend reward offer based on the given combination that maximizes profits resulting from the offer in the simulation.

15. A computer program product comprising a computer usable medium having control logic stored therein for causing a computer to increase incremental spend by a consumer, said control logic comprising:
first computer readable program code means for causing the computer to calculate a predicted spend of the consumer over a given time period;
second computer readable program code means for causing the computer to set a spend threshold for the consumer based on the predicted spend over the given time period; and
third computer readable program code means for causing the computer to reward the consumer for spend above the spend threshold during the given time period.

16. The computer program product of claim 15, further comprising:
fourth computer readable program code means for causing the computer to customize an incremental spend reward offer for the consumer that maximizes profits resulting from the offer based on a calculation of consumer profits; and
fifth computer readable program code means for causing the computer to provide the consumer with the customized incremental spend reward offer.

17. The computer program product of claim 16, wherein the calculation of consumer profits provides an optimal value for at least one variable, wherein the at least one variable is at least one of: spend threshold, duration, rewards cap, and fee.

18. The computer program product of claim 16, further comprising sixth computer readable program code means for causing the computer to link the customized incremental spend reward offer with an RSVP code that allows validation of the calculation of consumer profits.

19. The computer program product of claim 16, further comprising:
sixth computer readable program code means for causing the computer to send offers for rewarding incremental spend having a plurality of offer types to consumers, each offer type having a different combination of incentive variables;
seventh computer readable program code means for causing the computer to receive at least one of enrollment data or usage data for each set of offers;
eighth computer readable program code means for causing the computer to map each incentive variable to a spend behavior for a given consumer level based on the at least one of enrollment data or usage data;
ninth computer readable program code means for causing the computer to develop a set of consumer behavior models based on the mapped variables; and
tenth computer readable program code means for causing the computer to derive the calculation of consumer profits based on at least one of the mapped variables, business financial inputs, and business judgments.

20. The computer program product of claim 16, wherein the fourth computer readable program code means comprises:
sixth computer readable program code means for causing the computer to simulate a response of the consumer to a plurality of offers having different combinations of incentive variables based on the calculation of consumer profits to identify a profit; and
seventh computer readable program code means for causing the computer to set the incentive variables in the customized incremental spend reward offer based on the given combination that maximizes profits resulting from the offer in the simulation.
